(19) United States
(12) Patent Application Publication
(10) Pub. No.: US 2009/0214723 A1
(43) Pub. Date: Aug. 27, 2009

(54) Two Component Package for Simultaneous Heating

(76) Inventor: Joseph Paul Sagel, Plano, TX (US)

Correspondence Address: CARSTENS & CAHOON, LLP, P O BOX 802334, DALLAS, TX, 75380, US

(21) Appl. No.: 12/037,522

(22) Filed: Feb. 26, 2008

(51) Int. Cl. A23L 1/025; B65D 85/00; B65B 25/22

(52) U.S. Cl. 426/120; 426/119; 426/392; 426/234

(57) ABSTRACT

An improved package for heating two complimentary food products is provided. The present invention allows a crispy food product and a non-crispy food product to be heated simultaneously in a microwave oven. The package is ideal for combinations of chips and salsa, chips and cheese, or any other compatible crispy and non-crispy food products that are desirably kept in separate containers and heated shortly before consuming.

### BACKGROUND OF THE INVENTION

1. Technical Field

The present invention relates to packaging food containers so they are suitable for being stored together and simultaneously heated in a microwave.

2. Description of Related Art

The design and construction of packaging for containers of consumables, such as potato chips, tortilla chips, corn chips or other snack food products, involves consideration of application specific criteria. For example, mixing separate, complementary food products just prior to consumption is often popular with consumers. Therefore, it may be desirable to construct a container or container packaging so that two or more complementary food products can be sold and consumed together.

Furthermore, food ingredients are typically enclosed in a scaled food package and thus approach equilibrium with the relative humidity inside the package. Thus, moisture migration can make it difficult to achieve a long shelf life on multiple compartment packages if snack products are stored sharing the same head space. Additionally, oxygen and moisture migration into a container reduces the product's shelf life.

It is also desirable to heat some food products before they are consumed. However, some food products that the consumer desires to combine react differently to various heating methods. These differing reactions to heating methods make it counterintuitive to heat different types of consumables together. The particular method used to heat the food products also affects the product packaging.

The prior art fails to disclose a container having all of the above advantages and taking into account all of the above considerations. Consequently, a need exists for a packaging of food containers that allows a consumer to easily heat and consume multiple food products within the same package at the same time. Such design should be simple and inexpensive to manufacture and be intuitively functional to the consumer.

### SUMMARY OF THE INVENTION

The proposed invention comprises a packaging scheme for food product containers and a method that allows multiple different types of food products to be packaged and heated together at the same time. In one embodiment, a non-crispy food product is placed into a first container, and a crispy food product is placed into a second container. The second container is then packaged together with the first container such that when the package is placed into a microwave oven, the first container is held in place on top of the second container. In this way, both food products can then be stored, sold, and heated in a single package providing convenience to the consumer.

The invention is simple and inexpensive to manufacture, provides adequate protection for the product contained therein, and is easy to use for the consumer. The container is an improvement over the prior art in the packaging efficiencies and functional use by the consumer. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view illustrating one embodiment the first food container of the present invention;

FIG. 2 is a perspective view illustrating one embodiment the second food container of the present invention;

FIG. 3 is a perspective view of one embodiment of the packaging of the present invention;

FIG. 4 is a schematic view of food containers of the present invention inside the food chamber of a microwave oven.

### DETAILED DESCRIPTION

Crispy snack food products, such as tortilla chips, potato chips, corn chips, fruit and vegetable chips, crackers and pretzels, are typically consumed at room temperature because they are sold in individual single serving or multiple serving packages from convenience stores or grocery stores to consumers long after the snacks have been cooked. However, some restaurants offer these snack food products to consumers fresh from the cooking medium, and thus still hot. Other restaurants offer the snack items warm to consumers by temporarily storing them under warming lamps or the like. The term “crispy food product” as used herein is defined as a food product comprising less than 3% moisture by weight.

These crispy snack food products are also typically consumed with a complimentary non-crispy food such as a condiment or dipping sauce (sometimes referred to as “dip”). Examples of dipping sauces include cheese sauce, salsa, chili, soups, stew and bean dip. Here again, dipping sauces are typically sold from grocery or convenience stores to consumers at room temperature long after they have been cooked or prepared. Restaurants, however, routinely offer these dipping sauces in their freshly prepared or still hot form. The term “non-crispy food product” as used herein is defined as a food product with a moisture content between about 40% and about 80% by weight. The term “product” as used herein is includes a single product, a group of products, or a mixture of products.

One goal of the present invention is to provide consumers the ability to easily and efficiently replicate the restaurant experience of eating hot crispy snacks with hot dipping sauces using products purchased at grocery or convenience stores. In the prior art, a consumer would have to purchase the crispy snack food and the dipping sauce separately. The consumer would also also intuitively heat the crispy snack food and dipping sauce separately. The present invention allows consumers to purchase both foods together, and heat them both at the same time.

The present invention is also directed towards a method of heating both food products at the same time using a microwave oven. The microwave oven is an appliance that can be found in many homes and businesses. During operation, a microwave oven floods the cooking chamber with non-ionizing microwave radiation, usually at a frequency of about 2.45 GHz. The power level of most consumer grade microwaves varies from about 900 Watts to about 1400 Watts.

Many food molecules (for example water molecules) are electric dipoles, which means they are positively charged at one end and a negatively charged at the other end. As the microwave radiation passes through the food, the dipole molecules rotate as they try to align themselves with the alternating electric field of the microwaves. This rotation and movement causes the food to heat up as the rotating molecules impact other molecules, putting them into motion. Microwave heating is highly efficient on liquid water (which a relatively polar molecule), and much less so on fats and sugars (which are less polar).

The microwave radiation is produced by a cavity magnetron, and directed into the food chamber through a waveguide. The waveguide in most small, consumer grade microwaves directs the microwave radiation into the food chamber from one side of the food chamber, usually at a location between the middle and the top of the food chamber. The microwave radiation generally reflects off the walls of the food chamber, but is absorbed by any water bearing food present in the food chamber, thereby exciting the water molecules. The radiation reflecting around inside the food chamber forms an approximately uniform heating environment, with some localized hotspots due to constructive interference between microwaves.

Most food products that contain water can be heated effectively in a microwave oven. However, because the activity and efficiency of the microwave heating largely depends on the amount of water present in the food being microwaved, foods containing different levels of water heat at different rates when separately heated in the same microwave. For example, in the context of the present invention, heating about two ounces of a crispy food product, such as tortilla chips, alone inside a microwave will badly burn the chips after about 40 seconds to about 75 seconds, depending on the power level of the microwave. By contrast, when about 7 ounces of a non-crispy condiment that is typically combined with a crispy food, such as cheese dip, is put into a microwave by itself for between 60 and 75 seconds, it generally heats to a temperature between about 150° F. and about 200° F., which is an acceptable and desirable temperature range for most dips. As can be seen, it would be counterintuitive to combine the chips, which burn during these time frames alone in the microwave, with the dip, which heats acceptably well during these time frames alone in the microwave.

Applicants herein have discovered that not only does placing the crispy food and the non-crispy food in the microwave at the same time but in separate food containers result in both foods being heated, without burning, to a temperature range that is acceptable to consumers, but Applicants have also determined that the orientation of the two food containers relative to each other is a very important factor in the resulting temperature of each food after heating.

Applicants have experimentally determined that placing a food container containing non-crispy food on top of a container containing crispy food and microwaving both at the same time for a dwell time between about 50 and about 75 seconds results in both foods being heated to a temperature between about 130° F. and about 200° F., which is within the temperature range that consumers find acceptable and desirable. When experiments were run with the crispy food container on top of the non-crispy food container, the crispy food did not get as hot or heat as consistently as it did when it was placed underneath the non-crispy food. This result was surprising and unexpected because one skilled in the art would expect the crispy food to heat up more rapidly when placed on top of the non-crispy food as the crispy food would then be closer to path of microwaves exiting the waveguide and un-shielded by the non-crispy food. Conversely, when the non-crispy food is placed on top of the crispy food in accordance with the present invention, one would expect the non-crispy (and moisture rich) food to be a microwave susceptor and shield the crispy food below it from absorbing microwave radiation. The principles of the present invention were verified across a number of different food products, microwave manufacturers and microwave power levels.

In one embodiment of the present invention, a first food container that contains a non-crispy food product such as a condiment or dip is packaged together with a second food container that contains a crispy food product such that the first container is located above the second container when the package is placed into the microwave. The crispy and non-crispy food products cannot be packaged in the same head space because moisture would migrate from the non-crispy food product to the crispy food product, ruining both products. Furthermore, because the containers are meant to be heated in a microwave oven, the container should be made of a microwave safe material. In one embodiment, the food containers of the present invention comprise at least one of the following materials: crystallized polyester, polypropylene, and ethylene vinyl alcohol.

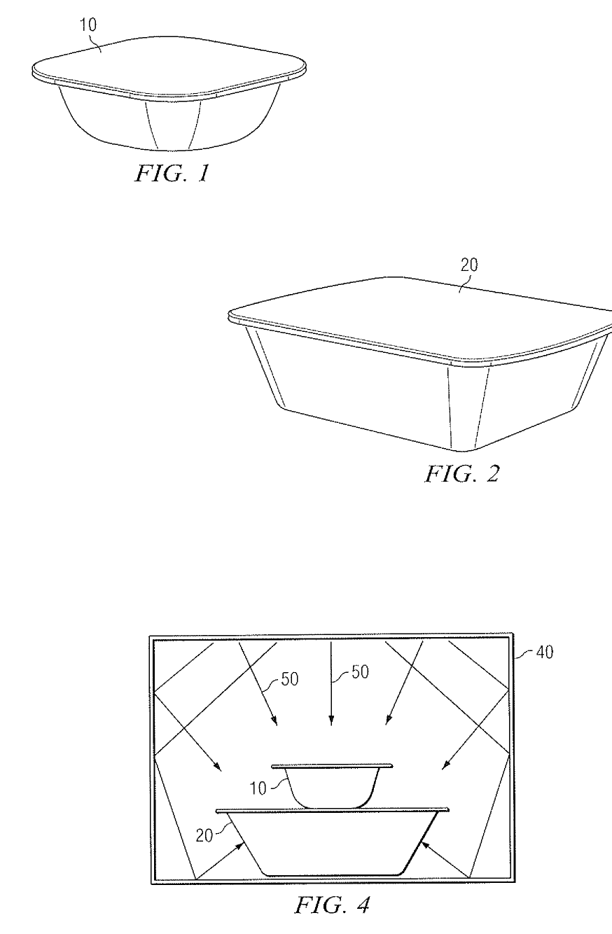

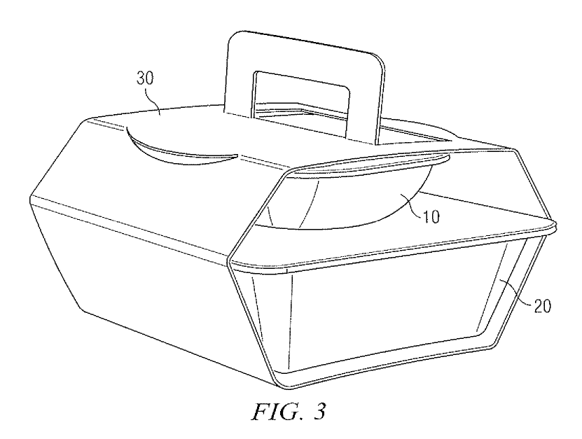

FIG. 1 depicts one embodiment of a first food container 10 adapted to contain a non-crispy food products such as a condiment or dip. FIG. 2 depicts one embodiment of a second food container 20 adapted to contain crispy food products such as snack chips. The top surface of the second food container 20 should preferably be flat, or otherwise capable of allowing the first food container 10 to sit on top of it inside a microwave oven. FIG. 3 depicts one embodiment of the package cover 30 of the present invention for the first food container 10 and second food container 20. In one embodiment, the packaging sleeve 30 can be a paper board or cardboard sleeve that is designed to hold the first food container 10 on top of the second food container 20 while inside a microwave oven. The packaging sleeve may also be made of polypropylene or any other microwave safe, non-metallic packaging material known in the art. The packaging sleeve may contain heating instructions for the food products in the containers it houses. FIG. 4 depicts the first food container 10 on top of the second food container 20 and packaging sleeve 30 inside a microwave oven food chamber 40 flooded with microwave radiation 50.

In one embodiment of the present invention the weight ratio of non-crispy food to crispy food should range between about 3:1 and about 1:1 to allow both to heat well together. In another embodiment, the total weight of the non-crispy food ranges between about 4.5 ounces and about 9 ounces, and the total weight of the crispy food ranges between about 1.5 ounces and about 4.5 ounces.

### EXAMPLES

A first set of experiments were run to determine whether it was possible to heat a crispy and a non-crispy food in a microwave simultaneously. Tests were run that heated Fritos Scoops (3.0 ounces) or Fried Tostitos Scoops (2.5 ounces) in varying combinations with the dips (7.0 ounces) ounces) described below in different arrangements relative to each other in a microwave oven for about 60 seconds. In some tests, the container of chips was placed on top of the dip container, and in other tests the container of chips was placed underneath the dip container. The microwave oven that was used in these initial tests was a GE model JES1039F001, manufactured in April 2002. The temperature of the food products was measured using an infrared thermometer. These initial tests showed that when the food container that contained the non-crispy food product was placed below the food container that contained the crispy food product, the crispy food (chips) were, on average, approximately 60° F. cooler than they were when the non-crispy food container was placed on top of the crispy food container. Furthermore, the results of the tests with the crispy food item on bottom were more consistent and repeatable than the tests with the crispy food item on top.

After it was determined that placing the non-crispy food product on top of the crispy food product, a design of experiments (DOE) was conducted on various crispy food, non-crispy food, and microwave manufacturer combinations to verify the effectiveness of the present invention. The following table depicts the combinations of crispy and non crispy foods used in the DOE:

TABLE 1

| Crispy Food | Non-Crispy Food |
|---|---|
| Baked Tostitos ® Scoops (2.5 ounces) | Veggie Chili Dip (7 ounces) |
| Baked Tostitos ® Scoops (2.5 ounces) | Chicken Taco Dip (7 ounces) |
| Fried Tostitos ® Scoops (2.5 ounces) | Beef Nacho Dip (7 ounces) |
| Fried Tostitos ® Scoops (2.5 ounces) | Beef Taco Dip (7 ounces) |
| Fritos ® Scoops (3 ounces) | Chili (7 ounces) |

Each of these combinations of crispy and non-crispy food were heated in accordance with the present invention (i.e. non-crispy food container placed on top of crispy food container) in the following microwaves: GE 700 W unit manufactured in 2005; Kenmore 900 W unit manufactured in in 1994; GE 1000 W unit, model number JES1039WF001, manufactured in 2005; and Sharp 1250 W unit, model number R403KK, manufactured in 2005. Each combination was heated in each microwave oven for the following periods of time: 30 seconds; 45 seconds; 60 seconds; and 75 seconds. Thus, 16 tests were conducted for each combination of chip and dip, for a total of 80 tests.

The results of the DOE showed that when the teachings of the present invention are followed, and the chip and dip combination was heated for 60 seconds to 75 seconds, that both the chips and the dip heated to the desirable temperature range between about 130° F. and about 200° F. Furthermore, at these dwell times in these microwave ovens, the vast majority of the tests revealed that no chips were burned or scorched at all during the tests, and that even in those few tests that did result in minor chip scorching, at most two (2) chips were ever adversely affected. These may have resulted from localized hot spots in the food chamber where microwaves were constructively interfering. This DOE verified previous experiments that proved not only that crispy and non-crispy foods could be heated together in a microwave oven, but also that it is optimum to place the non-crispy food on top of the crispy food during the microwave heating.

While the invention has been particularly shown and described with reference to a preferred embodiment, it will be understood by those skilled in the art that various changes in form and detail may be made therein without departing from the spirit and scope of the invention.

What is claimed is:

1. A food product package comprising:
a first food container adapted to hold a non-crispy food product;
a second food container adapted to hold a crispy food product;
a packaging sleeve in contact with said first food container and said second food container and adapted to hold said first food container on top of said second food container.

2. The package of claim 1 wherein said non-crispy food product is at least one of salsa, cheese dip, chili, soup, stew and bean dip.

3. The package of claim 1 wherein said crispy food product is at least one of tortilla chips, potato chips, corn chips, pretzels, fruit chips, vegetable chips and crackers.

4. The package of claim 1 further comprising a weight ratio of said non-crispy food product to said crispy food product between about 3:1 and about 1:1.

5. The package of claim 1 wherein said non-crispy food product comprises a moisture content between about 40% and about 80% by weight.

6. The package of claim 1 wherein said crispy food product comprises a moisture content less than about 3% by weight.

7. A method of packaging food products, said method comprising:
providing a first food container that contains a non-crispy food product;
providing a second food container that contains a crispy food product;
stacking said first food container on top of said second food container;
holding said first food container on top of said second food container with a packaging sleeve.

8. The method of claim 7 wherein said non-crispy food product comprises a moisture content between about 40% and about 80% by weight.

9. The method of claim 7 wherein said crispy food product comprises a moisture content less than about 3% by weight.

10. The method of claim 7 wherein said non-crispy food product is at least one of salsa, cheese dip, chili, soup, stew and bean dip.

11. The method of claim 7, wherein said crispy food product is at least one of tortilla chips, potato chips, corn chips, pretzels, fruit chips, vegetable chips and crackers.

12. The method of claim 7, wherein said providing said first food container and said providing said second food container further comprise providing said non-crispy food product and said crispy food product in a weight ratio of said non-crispy food product to said crispy food product between about 3:1 and about 1:1.

13. A method for heating food products, said method comprising:
providing a first food container that contains a non-crispy food product;
providing a second food container that contains a crispy food product;
stacking said first food container on top of said second food container to make a container stack;
placing said container stack into a microwave oven; and
heating said container stack until said non-crispy food product and said crispy food product have reached a temperature between about 130° F. and about 200° F.

14. The method of claim 13 wherein said non-crispy food product comprises a moisture content between about 40% and about 80% by weight.

15. The method in claim 13 wherein said crispy food product comprises a moisture content less than about 3% by weight.

16. The method of claim 13 wherein said non-crispy food product is at least one of salsa, cheese dip, chili, soup, stew and bean dip.

17. The method of claim 13 wherein said crispy food product is at least one of tortilla chips, potato chips, corn chips, pretzels, fruit chips, vegetable chips and crackers.

18. The method of claim 13, wherein said providing said first food container and said providing said second food container further comprise providing said non-crispy food product and said crispy food product in a weight ratio of said non-crispy food product to said crispy food product between about 3:1 and about 1:1.
